(19) United States
(12) Patent Application Publication
(10) Pub. No.: US 2013/0317956 A1
(43) Pub. Date: Nov. 28, 2013

(54) METHODS AND APPARATUSES FOR FACILITATING DISTRIBUTED OWNERSHIP AND MANAGEMENT OF RENEWABLE ENERGY RESOURCES

(71) Applicants: Paul W. Droege, Tijeras, NM (US); Donald F. Hicks, Albuquerque, NM (US)

(72) Inventors: Paul W. Droege, Tijeras, NM (US); Donald F. Hicks, Albuquerque, NM (US)

(21) Appl. No.: 13/898,468

(22) Filed: May 21, 2013

Related U.S. Application Data
(60) Provisional application No. 61/650,323, filed on May 22, 2012.

(51) Int. Cl. G06Q 40/00

(52) U.S. Cl. CPC G06Q 40/10
USPC 705/30

(57) ABSTRACT

Methods and apparatuses can provide for easier access to renewable energy resources such as solar through distributed ownership and/or management. The invention can be implemented using computers, for example using one or more computers connected by a network such as the world wide web. Various computer and communication techniques can be used, including as examples desktop computers, servers, smart phones, tablet computers, wired computer networks such as Ethernet, wireless networks such as WiFi, and cellular and satellite communications networks. Embodiments of the present invention can use centrally sited systems, that can be built similarly to large commercial or utility scale systems with their attendant economies of scale. Individual owners can be true owners of specific individual assets, even if ownership is under tightly constrained conditions.

### CROSS REFERENCE TO RELATED APPLICATIONS

This invention claims priority to U.S. provisional 61/650,323, filed 22 May 2012, which is incorporated herein by reference.

### FIELD OF THE INVENTION

This invention relates to the distributed ownership and management of renewable energy resources.

### BACKGROUND ART

The concept of “personal green power” (PGP) has an inherent attraction to virtually any private energy user. Owning a resource that produces “free” energy with no cost for fuel has an obvious attraction for anyone. Reducing the environmental impact of our energy-intensive lifestyles and “saving the planet” is an attraction that draws many people as well. Today, the only realistically viable choice for a personal green power source is solar photovoltaic (PV) and it does deliver on the promise of helping save the planet, even if each system is only a tiny piece of the solution. The present invention is described herein in the context of solar photovoltaic, but that should not be construed as limiting the invention. The invention can be useful with other renewable energy sources, as examples including geothermal, wind, biomass, microhydro, and tidal.

With the high initial capital cost of a solar PV system, free solar energy doesn't exist in any real sense, yet paying for power one time (in a system purchase) and being insulated from energy price volatility appeals to many. Financing a system and paying the debt with savings from the displaced source is appealing, if solar has parity with that former source. Combining these factors creates a potent attraction for many people.

A recent survey done by Schott Solar indicates that 92% of Americans are interested in solar power and roughly 49% of are considering solar energy for their home or business—this when the overall penetration of solar is in the low single digits at best and virtually non-existent in many areas. Even discounting this figure, the overall “personal solar power” (PSP) market potential is immense. In fact, with virtually all Americans consuming electric power, even those “not interested” in solar would be interested if the cost and power availability were right. In a sense, only economics limit a virtual 100% interest in personal solar power within the US.

It would seem that with such strong interest, the PSP market would be gargantuan. Although the market is definitely healthy and growing, numerous barriers to deployment presently restrict the actual market dramatically. As a result, the PSP industry is still in its infancy. The barriers that prevent people from participating are myriad but they generally fall into a couple broad categories. Although financial limitations are significant, it is believed that many people are actually held back by the complexity and inaccessibility of PSP for “average” people. The present invention provides methods and apparatuses that can provide for easier access to renewable energy resources such as solar through distributed ownership and/or management.

### BRIEF DESCRIPTION OF THE DRAWINGS

Various aspects and attendant advantages of one or more exemplary embodiments and modifications thereto will become more readily appreciated as the same becomes better understood by reference to the following detailed description, when taken in conjunction with the accompanying drawings.

FIG. 1 illustrates an organization of solar power generation.

FIG. 2 illustrates interactions between source hosts and destination partners.

FIG. 3 is an illustration of the operation of an embodiment of the present invention.

FIG. 4 is an illustration of an example web site interface for a user.

FIG. 5 is an illustration of interactions among a producer community.

FIG. 6 is an illustration of an example flow of Internal Credits among producers and destination partners.

FIG. 7 is an illustration of an example of Internal Credit redemptions, showing s-rec communication to a destination partner and financial or other consideration to Facilitator.

FIG. 8 is an illustration of Internal Credit and s-rec retirement.

FIG. 9 is an illustration of the role of the destination partner in the system.

### DISCLOSURE OF INVENTION

The present invention can be implemented using computers, for example using one or more computers connected by a network such as the world wide web. Various computer and communication techniques can be used, including as examples desktop computers, servers, smart phones, tablet computers, wired computer networks such as Ethernet, wireless networks such as WiFi, and cellular and satellite communications networks.

Embodiments of the present invention are based on centrally sited, individually owned resources. These centrally sited systems can be built similarly to large commercial or utility scale systems with their attendant economies of scale. Individual owners can be true owners of specific individual assets, even if ownership is under tightly constrained conditions. These conditions mean that ownership or renewable energy resources under embodiments of the present invention differs greatly from residential rooftop ownership, in much the same way that condominium ownership differs from single family home ownership. Note that “ownership” as contemplated herein can comprise ownership of all or part of a physical installation, or can comprise a claim to rights to certain attributes of the installation such as energy credits.

Embodiments of the present invention leverages the modularity of PV systems and the fungibility of electric power, allowing a complete unlinking of the ownership of PSP resources from the owner's location. This simple step changes everything. Suddenly, virtually anyone can have a PSP system based on near-ideal conditions. Local limitations vanish. Apartment and condo dwellers can be PSP owners. Moving doesn't mean selling your system. Long-term financing now makes sense. System standardization and optimization now make sense. A true mass market is enabled.

Simplicity—becoming an owner of PSP under embodiments of the present invention is as easy as buying something online. The prospective owner goes to a secure website, makes some basic decisions about his objectives and desire to experience a PSP system, provides some personal information, provides a means of payment (or down payment). There is no design process, permitting or approval, installation scheduling or other hassles for the customer to deal with. There is nothing that must be installed at the new customer's home. There are no local rules to understand. Becoming a customer and ownership of a PSP system are streamlined to be easy and effortless.

Virtuality—Customers enjoy the benefits of PSP without the hassles of being the host site. Embodiments of the present invention provide for all aspects of hosting and caring for the system. The entire experience of owning PSP is altered by non-locality of the systems, combined with a carefully orchestrated, digitally mediated ownership experience. PSP ownership takes on a “second life” aspect of virtuality, except real power is generated from a real system and long-term financial benefits of actual ownership accrue. The net result is that interested owners can have active participation in the mediated ownership experience; those without such interest can completely ignore the system and leave it on “autopilot”. In both cases, ownership hassles are removed to make the experience “friction-free”.

Front-end Focus—Embodiments of the present invention provide the ability to open PSP to everyone and maintain the customer relationships. Embodiments of the present invention can make PSP ownership experience easy, economical and pleasant.

Mass customization—Because of the modularity of PV solar and the mediated ownership experience provided by the present invention, customization of the ownership experience is relatively straightforward. The customer defines certain parameters of their desired PSP experience by answering a number of simple, jargon-free questions, for example on a website. These responses tailor the scaling of the system itself, the contract and the customer's interface and virtual experience. Customers can easily tailor their system and contract to achieve specific personal objectives like covering their carbon footprint or eliminating their power bill.

Embodiments of the present invention allow private individuals to purchase qualified rights to the environmental attributes of solar PV installations, sited on the property of third parties.

These private individuals can obtain the qualified rights by “sponsoring” a portion of an installation that generates the environmental attributes. Functionally, the sponsorship will have some similarity to the private individual buying (an indeterminate number of) SRECs on a prepaid basis, though the actual mechanism is considerably different than a direct purchase of SRECs.

A first party will build (and potentially own) third party sited PV installations. As part of the siting agreement, the first party will hold a long-term PPA with the host, for off-take of all the PV system's electrical power on a net-metered basis (“inside the fence”). The PV system will offset a portion of the host's cost of traditional utility power consumption, for which the host will pay the first party on a recurring billing cycle. It is expected that the PPA kwh price will be somewhat less than the host's standard utility power rate. It is also expected that the PPA income to the first party will be sufficient to offset the cost of these solar installations, provided a suitable debt structure is obtained. As part of the terms of the PPA, the SRECs generated by these installations will be retained by the first party for its own use.

The sponsorships will constitute a service fee directly paid to the first party and will be granted as a time-limited, output of environmental attributes, proportional to actual power production of a corresponding increment of solar generation. “Points” designating a small increment of such production will be awarded to sponsors at a rate proportional to the generation output, and accumulated in an associated account within the first party's database. The first party will retain actual ownership and control of the SRECs, and the points will function as a claim against the first party for SRECs, provided other certain other conditions are met. The first party will only sell SRECs that are unencumbered by points, but to the extent the first party holds SRECs in excess of sponsorship claims, the first party may choose to sell those SRECs through any legal avenue.

The first party will recruit various consumer oriented businesses interested using solar power, to purchase SRECs at an attractive rate from the first party, in conjunction with collecting points from sponsors. Once sponsors have accumulated some points, they can “spend” them with these businesses for product discounts or other non-cash consideration. The businesses will make these point/discount offers to first party sponsors as part of their normal marketing and sales process. Once the businesses accumulate enough points from the sponsor community, they can submit them to the first party (retiring them) and pay an exchange/purchase fee (less than the open-market cost of SRECs), and receive actual SRECs from the first party. The businesses will then retire the actual SRECs against their own power consumption, thereby achieving solar energy objectives they have set.

Alternatively, the individual sponsors can also turn in their points directly to the first party (under certain pre-agreed terms), and then personally receive merchandise, services, additional increments of sponsorship, or actual SRECs in exchange (or at a suitable discount). There will also be other ways sponsors can gift, loan, spend, borrow or trade points with other members of the sponsor community, and also ways that they can earn additional points, beyond the output of their sponsored generation.

The first party can earn revenue by selling the sponsorships and charging certain associated siting fees; earning a management fee and/or margin on the revenue generated by the PPA's on the third-party sited systems they operate; selling certain merchandise and services; charging certain transaction fees to the sponsor community; earning the exchange/purchase fees charged to the businesses that buy SRECs and by selling those same businesses advertising targeted at the first party sponsor community; and (potentially) by arbitrage of SRECs within the larger solar community.

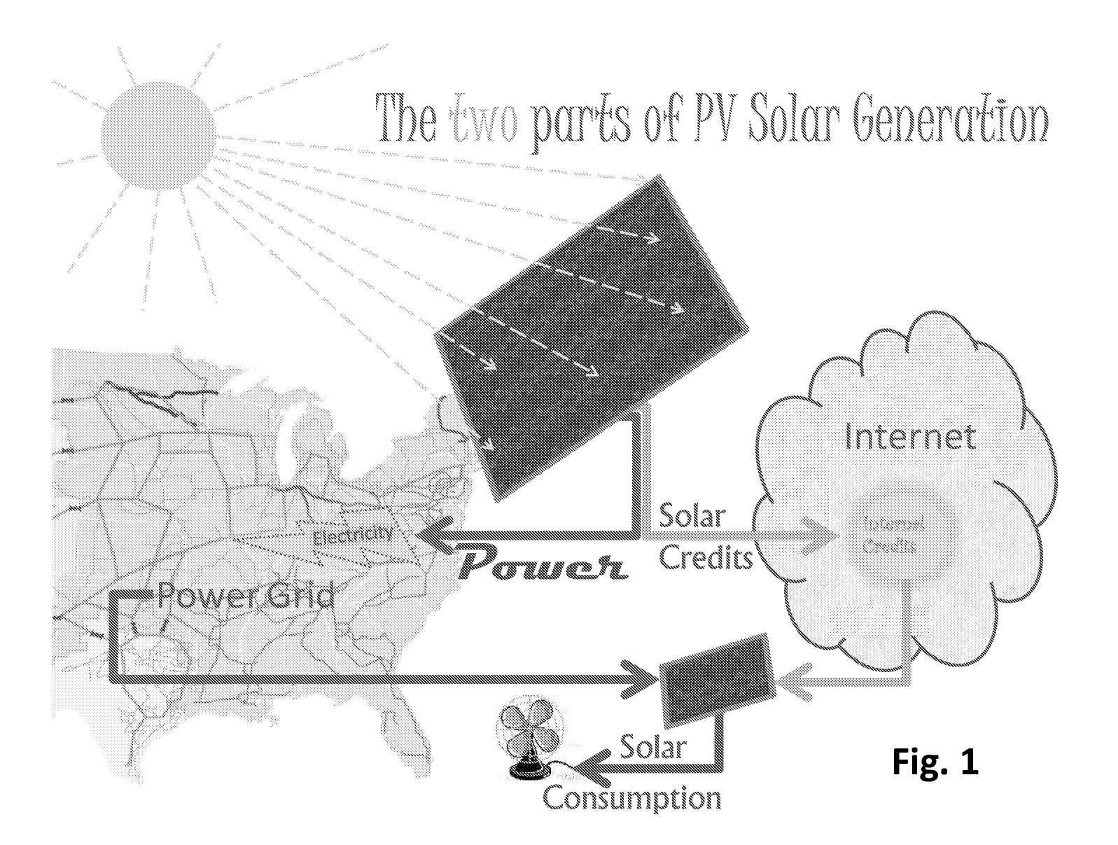

The description below refers to several types of participants and entities in relation to example embodiments of the present invention. The “Facilitator” generally refers to the entity or collection of entities that provide an overall framework, such as an internet communication system, for interactions with a plurality of other participants. The “Facilitation System” generally refers to the overall system, including interactions with participants and the web-based or other system providing tools that facilitate such interactions. A “Participant Producer” is an entity or collection of entities that acquires energy production capacity, such as discrete blocks of solar cells. “Internal Credits” are units of exchange within a system provided according to the present invention that allow tracking and trade in the benefits of the energy production separate from the electrical or other power actually produced. FIG. 1 illustrates an organization of solar power generation. Power is what turns on your lights & makes your appliances run. Power runs through copper wires as a stream of identical electrons, commonly known as electricity. Since each electron is indistinguishable from the next, they all just mix together in the huge ocean of electrical energy known as “The Power Grid”. They flow from wherever they're generated to wherever a load is connected to the grid. Electrical energy is normally invisible, but its presence is made visible in its effects, such as glowing lights or a spinning blender. Neither you nor your appliances can tell if the electrical power comes from a “green” or “brown” source.

That's where environmental benefits come in. They are the unique aspects of solar generation, in that it consumes no fuel and creates no emissions, which are really great benefits. These environmental benefits are absolutely real, but entirely intangible and completely independent of the electrons and wires! Though environmental benefits like reduced pollution and carbon emissions and stable prices, etc. undeniably exist, their effects are more subtle than those of electrical power. Because the embodiment of these benefits is only captured in some sort of abstraction like a credit, they are considered a virtual commodity.

The present invention provides an intermediate measure referred to herein as Internal Credits. For every increment of electricity produced from Facilitator's panels, there are a proportional amount of Internal Credits produced. Because they exist independent of wires and the power grid, Internal Credits are separated from the energy as a virtual commodity, and conveyed effortlessly to another location across the internet, allowing any electrical use to become consumption of solar energy.

When credits or Internal Credits are reunited with electrical energy and then retired at a point of consumption, they render that energy use as consumption of solar renewable energy. Facilitator takes advantage of all these properties to create a solar energy ecosystem.

To summarize, PV solar generation has two parts:

Energy generation, which sends electrical power through wires to be consumed somewhere on the grid.

And, virtual generation of solar benefits. Virtual Generation produces Internal Credits which can be reunited with power at the point of use, rendering that use as solar energy consumption.

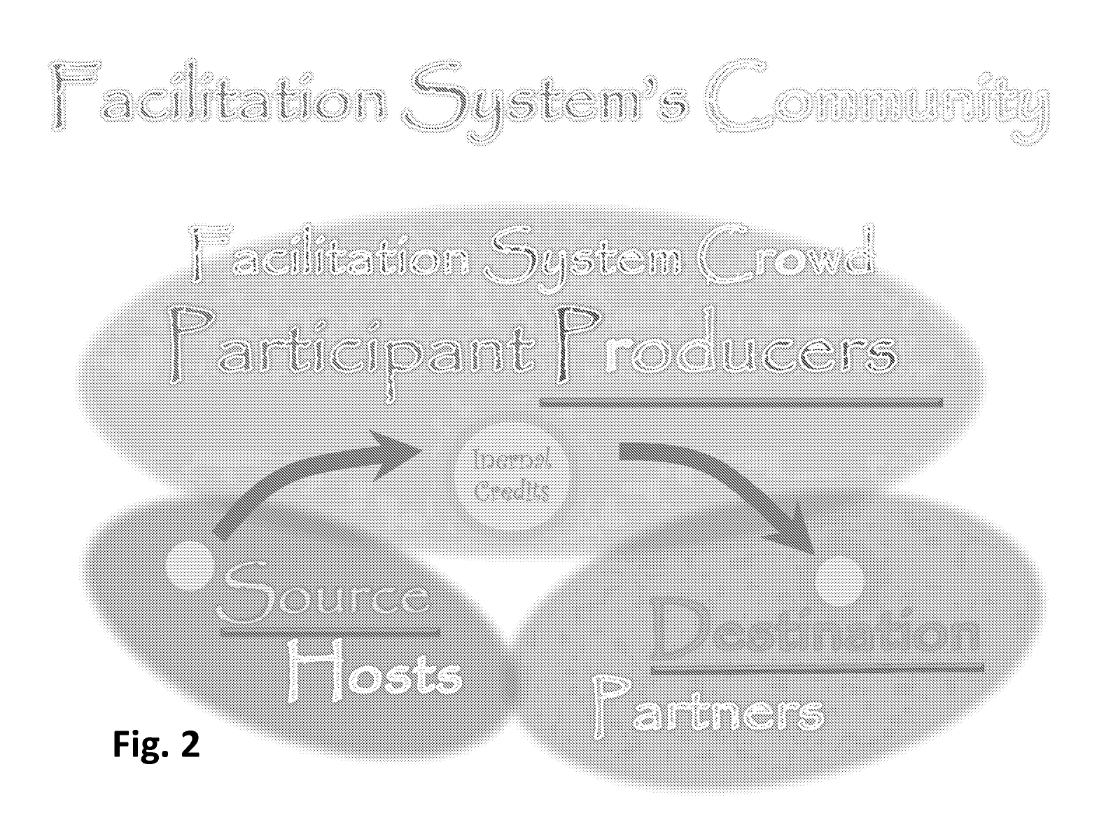

FIG. 2 illustrates interactions between source hosts and destination partners. The present invention connects three major groups, each distinct from the others in term of function, even though they might occasionally overlap.

First there's Facilitation System's crowd. This is a web-connected community of solar interested people including Participant Producers and any else who have chosen to get involved in making the solar future a reality. Anyone can easily signup online for free and instantly become a Participant. This crowd of Participants is the most important piece of the Facilitation System community, in that they produce Internal Credits as well as all the other activity in the Facilitation System ecosystem. This community of Participant Producers also serves as the conduit providing the vital connection between the other two groups in the larger Facilitation System community.

Next there are Source Hosts. These could be schools, churches, hospitals, charities, government buildings, or just regular businesses. They are various entities that consume electric power at a specific location which is also suitable for siting a PV installation. They are typically seeking to reduce their cost of power or hedge against future cost increases. Facilitator installs PV systems on Source Host facilities, as they are enabled by the Participant Producers, who have purchased the production of Facilitation System's Internal Credits, known as virtual generation.

As Facilitator PV systems operate at Source Host facilities, those systems originate Internal Credits which are conveyed to the Participant Producers. This process of collecting and distributing Internal Credits entails various challenges, connections and activities that make the Participant Producer role interesting, rewarding and fun. The Participant Producers ultimately distribute Internal Credits by taking them to Destination Partners. These are businesses interested in operating on solar energy they get from their customers.

The Participant Producers “spend” their Internal Credits with the Destination Partners, in exchange for special offers, discounts and other valuable benefits. By collecting the Internal Credits from the Participant Producers, the Destination Partners are accumulating solar production credits they can consume and claim as actual solar energy powering their businesses, while at the same time building stronger customer relationships and their credibility as environmentally conscious. The Destination Partners literally become solar powered by gathering Internal Credits from their customers!

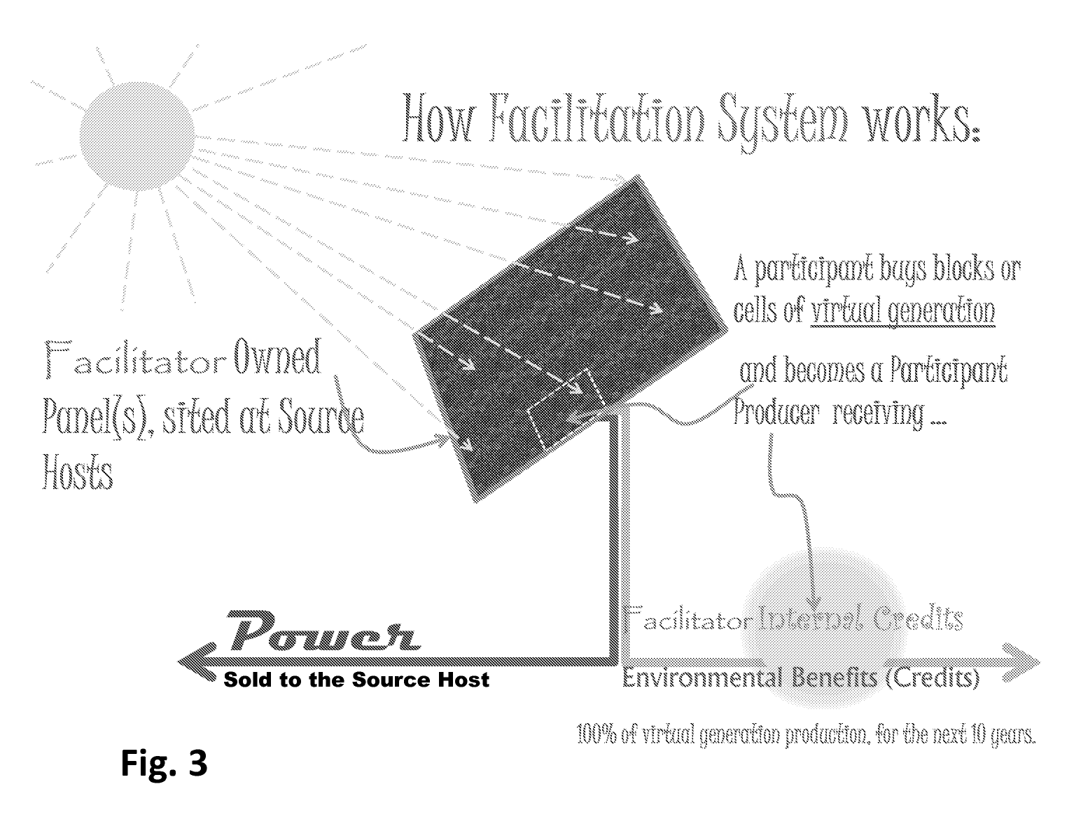

FIG. 3 is an illustration of the operation of an embodiment of the present invention. As an example, Facilitator builds new PV systems, normally sited on roofs of various Source Host facilities.

In exchange for siting a system, the Source Host makes a Power Purchase Agreement or, “PPA”, with Facilitator, which is a long-term contract to buy the electricity the system produces, typically for a discount versus utility rates. Facilitator offers the PPA at a price just barely above breakeven, so the PPA income helps defray the basic cost and operation of the system, but little else. This is to maximize the desirability of being a Source Host and to put Facilitator on the most competitive footing for getting systems built.

This same system also produces Internal Credits proportional to the power production, which are taken by Facilitator as part of the PPA. Facilitator accumulates the Internal Credits for distribution to its crowd of Producers.

Facilitator operates a website where solar interested people can get into the solar game. Anyone can become a Participant for free, earning a few Internal Credits just for signing up. As an example, each Facilitator panel can be associated with 16 shares of virtual generation or Internal Credit production, each known as a “Block”. Each Block can be made up of 4 smaller virtual generation shares, known as “Cells”. Once someone joins Facilitation System's crowd as a Participant, he or she can become a Participant Producer by simply buying a Cell or Block of Internal Credit production, sourced from Facilitator's solar panels.

As an example, cells can cost less than $10 and Blocks will be in the ˜$30 range. Every 4 Cells purchased automatically convert in to a V-Block. Since Facilitator still owns the panel, the cost of virtual production is just a small fraction of what an equivalent installed, producing panel actually costs. Participants will also have opportunities to earn and win virtual generation in certain situations and subscription discounts are also available.

Whether a Participant Producer owns a single cell or dozens of blocks, the Participant Producer's ownership of virtual production entitles her to 100% of the Internal Credit production of that ownership share, for some period of time, e.g., one month, three months, one year, two years, or longer in some applications. Longer terms may be offered for a nominal cost as well. Once someone becomes a Producer, she immediately begins accruing a stream of Internal Credits as Facilitator's panels produce energy.

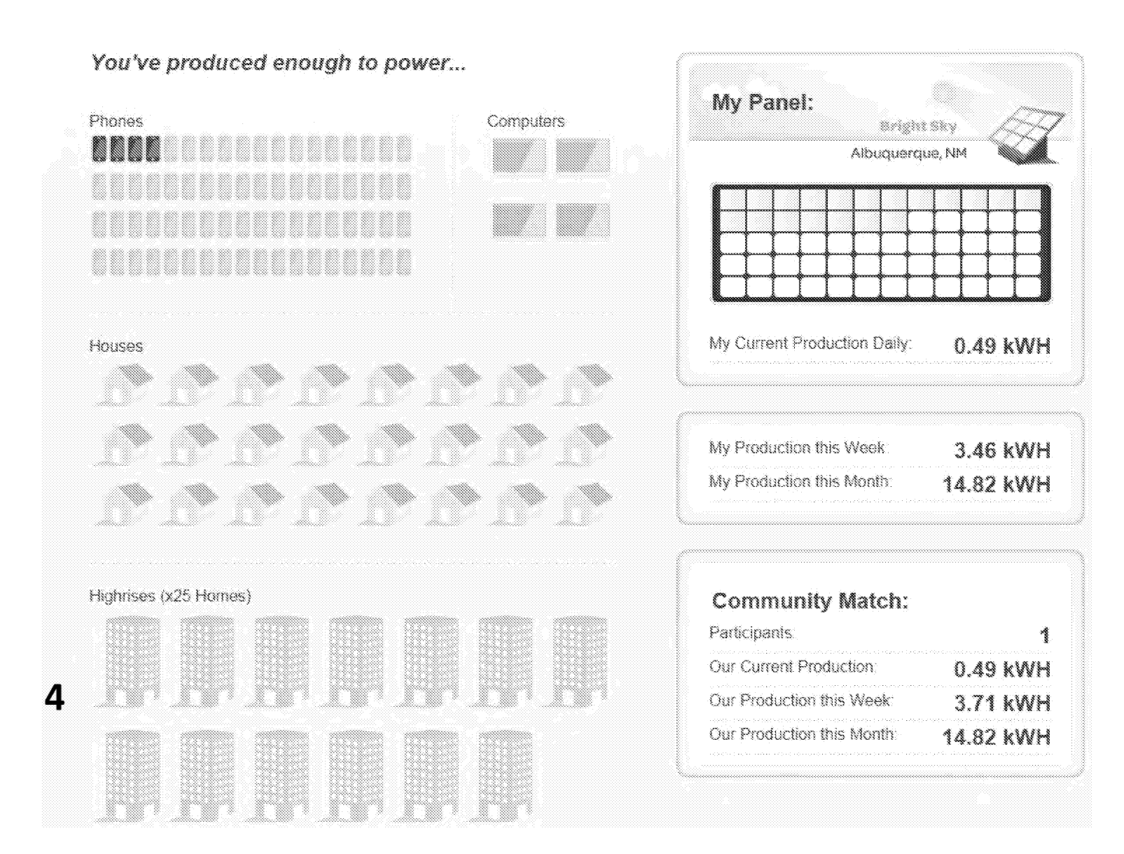

FIG. 4 is an illustration of an example web site interface for a user. In order to track her daily production, the new Participant Producer can login at Facilitation System's website or download applications that display her personalized production dashboard with real-time data. These apps are available for personal computers as well as tablets (like iPad) and smartphones, making it easy to do mobile production tracking, show-off to friends and spend Internal Credits at Destination Partners. No additional purchases ever need to be made by a Participant Producer, once she owns at least a cell. She may choose to buy additional cells or blocks however, and the more she owns, the faster the Internal Credits accumulate and the more she's doing to promote the solar economy.

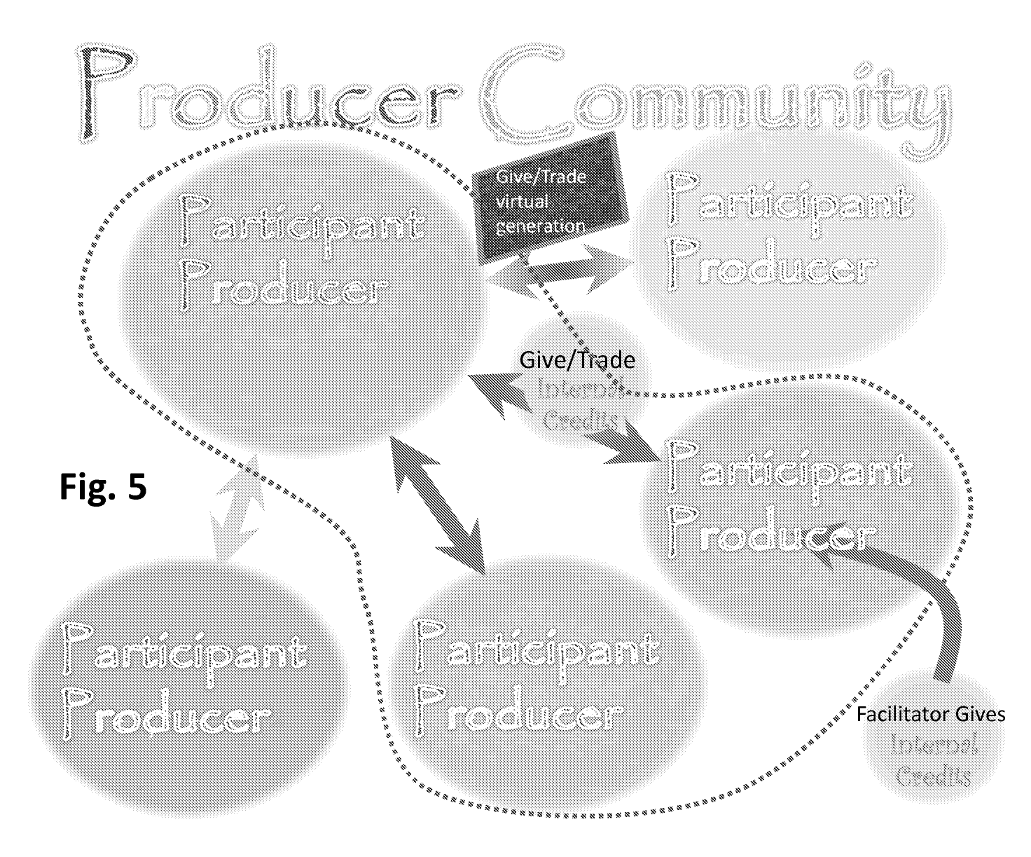

FIG. 5 is an illustration of interactions among a producer community. Each Participant Producer is of course an individual or entity, but they can exist within a larger community of Participant Producers. Some of those other Participant Producers can be people they have much in common with and may be friends and family, or people they have less in common with or little connection at all. Just like with any network, each member has their own set of connections and strong and weak links. There are opportunities for lots of different interactions within the community that take advantage of the presence and nature of those links. One type of interaction could be considered transactional, where one Producer gives or trades resources with another. These can be one time events or ongoing, planned and even programmed events. These are essentially private interactions and the terms are entirely up to the individuals, their imaginations and whatever motives they have, for whatever exchanges they choose to make. The Facilitation System platform supports and allows these types of transactions.

Another type of interaction can be more of a coordinated action or community event. A Participant Producer might choose to involve only a certain group or category of the larger community and they may have specific goal or purpose for the event. Any individual Participant Producer or group of Participant Producers can initiate one of these events. An example might be a “Challenge”, where they each try to accomplish something meaningful individually in competition or collectively toward a goal they set. These events could be done for amusement or for a cause, depending on the individuals, their motives and imaginations. Again, Facilitation System's platform supports and enables these type of events.

In addition, for appropriate causes and challenges, Facilitator might kick in additional support or incentives to help enhance the event. This might for instance be a group of people doing some sort of charitable drive, where Facilitator provides Internal Credits as awards for achievement or to enhance the impact of the effort.

The Participant Producer experience is a connected, interactive and social environment, rather than a static, anonymous experience like you might have with a frequent flyer program or any other sort of typical customer loyalty program. The system can provide tools for making the experience fully enabled and compatible with popular social networking sites like Facebook and Google+.

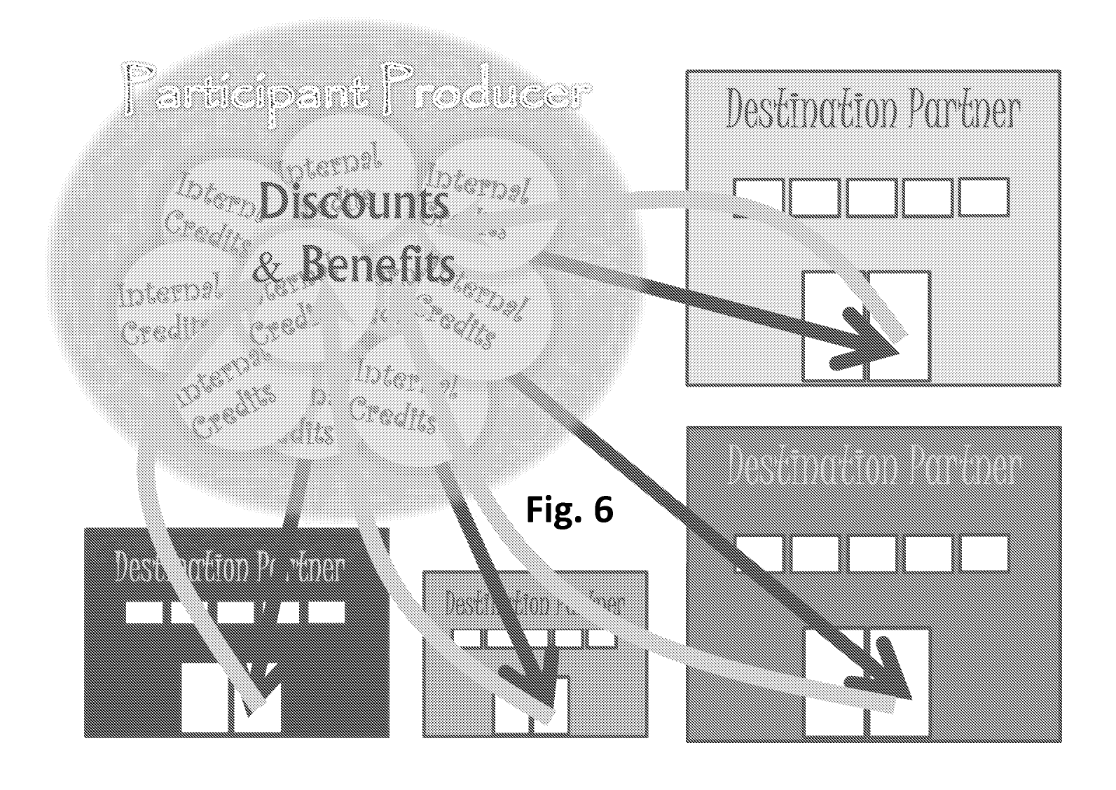

FIG. 6 is an illustration of an example flow of Internal Credits among producers and destination partners.

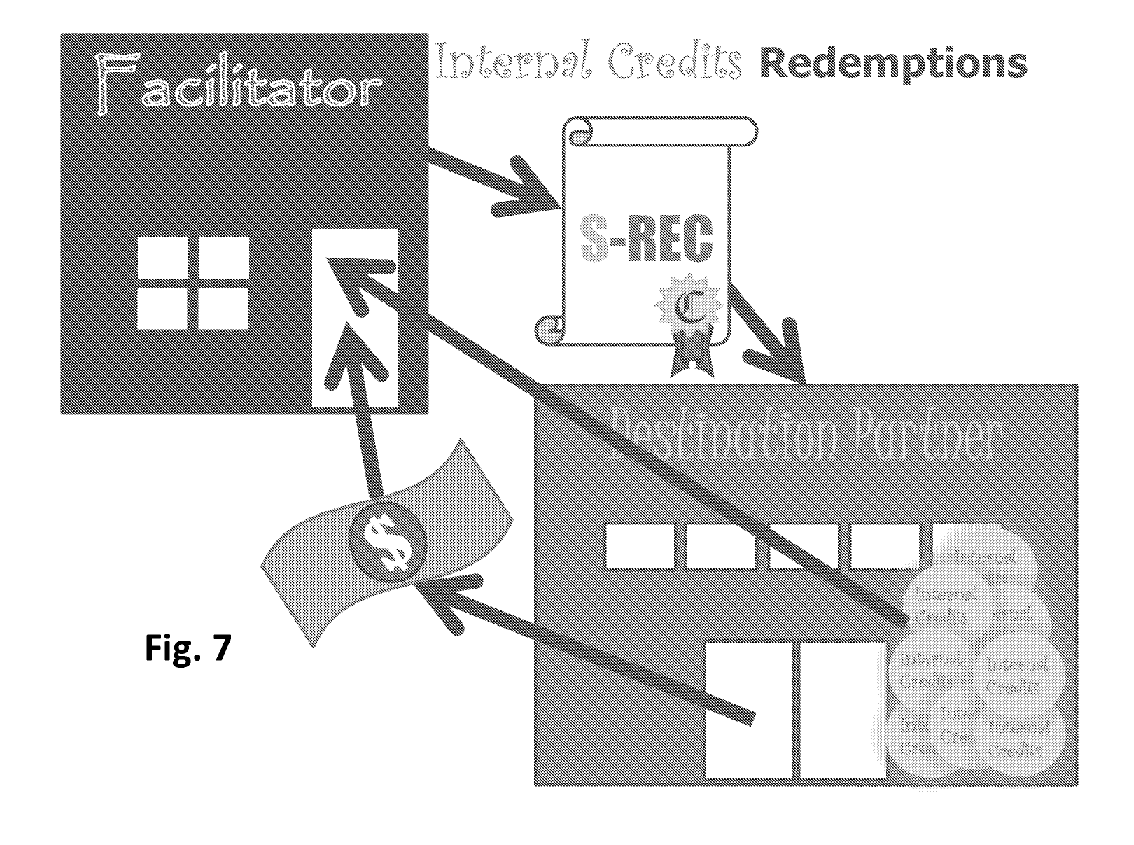

FIG. 7 is an illustration of an example of Internal Credit redemptions, showing s-rec communication to a destination partner and financial or other consideration to Facilitator.

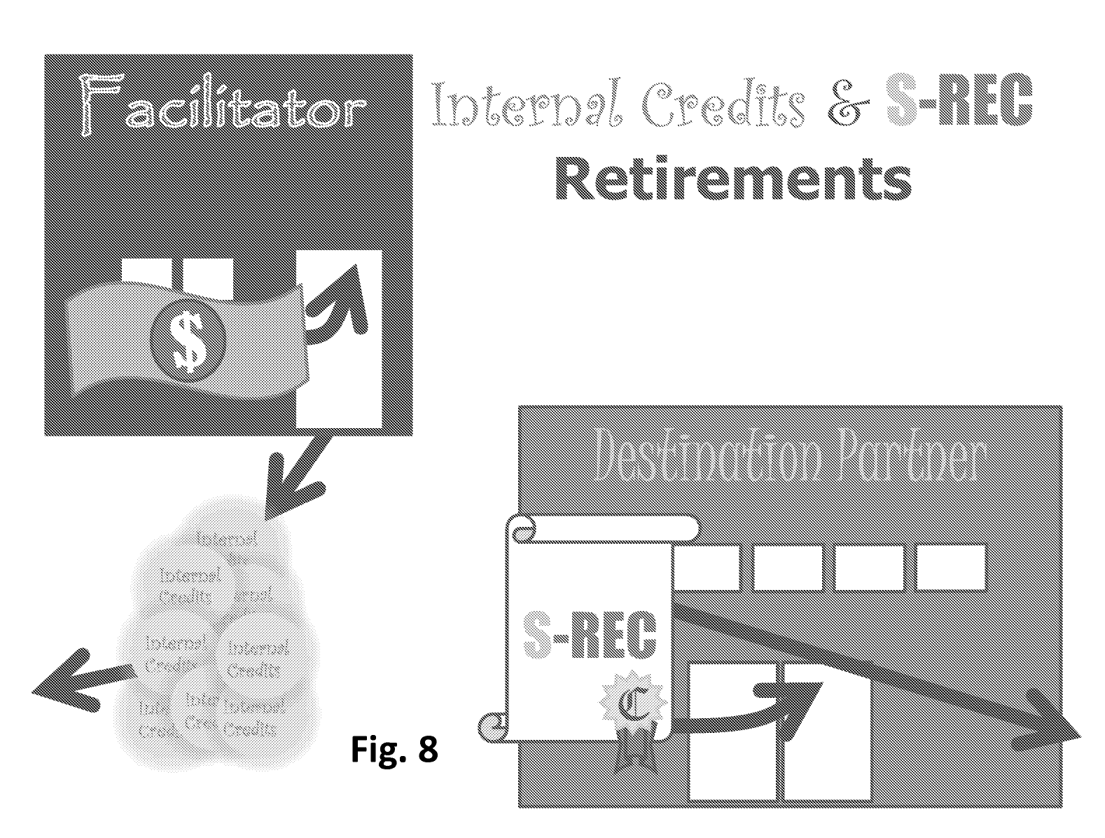

FIG. 8 is an illustration of Internal Credit and s-rec retirement.

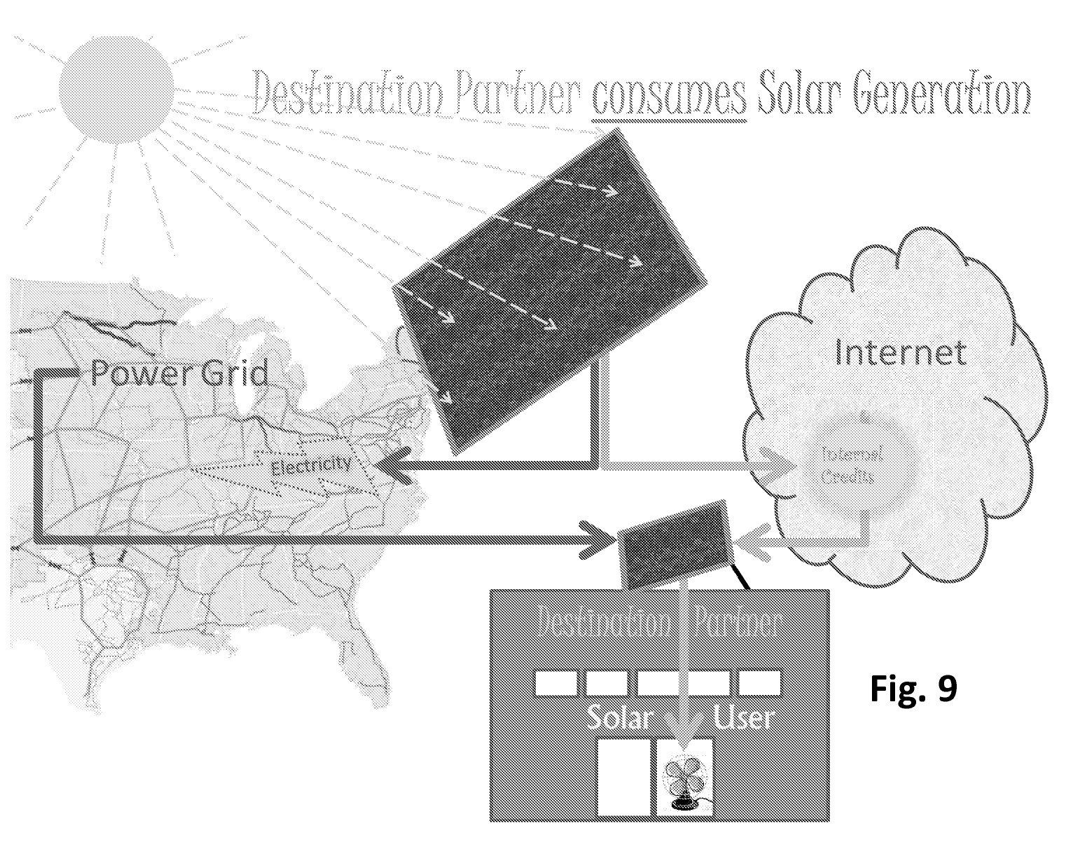

FIG. 9 is an illustration of the role of the destination partner in the system.

### Example Embodiments

Several example embodiments are described below.

An embodiment of the present invention can provide an auditable, internet-based software system for facilitating widespread use of renewable energy, comprising: (a) One or more data processing systems, configured to process and record data, and to communicate with users; (b) An accounting subsystem implemented in software on one or more of the processing systems, configured to maintain balances of renewable energy credit accounts corresponding to a plurality of users; (c) A credit adjustment subsystem implemented in software on one or more of the processing systems, configured to accept indications from a user corresponding to increases or decreases in a user's renewable energy credit account balance, and to communicate the increase or decrease with the accounting subsystem; and (d) A credit matching subsystem implemented in software on one or more of the processing systems, configured to match actual electricity usage with a user's account and communicate with the accounting subsystem an adjustment to the user's account balance responsive to the matched usage.

The accounting subsystem can be configured to accept only renewable energy credits certified by an operator of the system. The accounting subsystem can be configured to accept renewable energy credits from one or more validated sources other than the operator of the system. The unit of renewable energy credit in the accounting subsystem can represent between 0.01 to 1000 watt hours of energy. The accounting subsystem can be configured to accept external renewable energy credits corresponding to actual production of energy, and to translate such external credits to internal credits, wherein the internal credits comprise secure accounting tokens and are not used to track compliance with renewable energy credit legal requirements.

The accounting system can be configured to increase the balance in a user's account responsive to renewable energy credits obtained by the user according to the method described below. The credit adjustment subsystem can be configured to provide a competitive activity to a user, and to communicate to the accounting subsystem an adjustment in the user's account responsive to the user's participation in the competitive activity. The credit adjustment subsystem can be configured to accommodate transfers between accounts of users. The credit adjustment subsystem can be configured to communicate balance adjustments responsive web portals, power consumption meters, power production meters, power consuming devices, power producing devices, and mobile device apps. The credit matching subsystem can be configured to accept signals indicative of power consumption from power meters, web-connected appliances, web-connected power production devices, web-connected power consuming devices, or a combination thereof. The credit matching subsystem can be configured to accept signals indicative of power consumption from a meter connected with an electrical power grid and associated with a user. The accounting subsystem can be configured to aggregate renewable energy credits deducted from the accounts of a plurality of users and to retire standard RECs corresponding to the aggregated amount.

The system can further comprise a communication subsystem configured to communicate information concerning a user's account to one or more distinct processing systems. The one or more distinct processing systems can comprise one or more of: software operating on a personal computer, a web app accessible from a web-enabled device, software implementing a social media website, software implementing a personal website. The communication subsystem can be further configured to communicate information concerning combinations of user accounts to one or more distinct processing systems.

An embodiment of the present invention can provide a method of obtaining renewable energy credits from a renewable energy generation system, comprising: (a) Determining an amount of time during which the renewable energy is to be obtained; (b) Determining a first renewable energy generation system from which the renewable energy credits are to be obtained; (c) Determining a percentage of the output of the first renewable energy generation system which is to be obtained; and (d) Establishing a payment relationship between the obtainer and the first renewable energy generation system corresponding to the determined percentage and transferring the corresponding renewable energy credits to the obtainer.

The payment relationship can provide financing for the installation of the first renewable energy generation system. The determined percentage can be less than 1%. The renewable energy generation system can be a sanctioned system, and the renewable energy credits correspond directly to renewable energy produced by the first renewable energy generation system. The renewable energy credits can correspond to renewable energy produced by a second renewable energy generation system, distinct from the first renewable energy generation system, and equivalent to the determined percentage of the output of the first renewable energy generation system.

An embodiment of the present invention can provide a system for managing consumption of renewable energy, comprising: (a) A plurality of power consuming devices, each configured to communicate signals representative of power consumption to a computer network; (b) A communications system configured to accept power consumption signals from the devices and communicate with an accounting system; and (c) An accounting system implemented in software on one or more data processing systems, configured to maintain accounts for each of one or more users, where each account balance is adjusted responsive to power consumption of power consuming devices associated with the same user as the account.

The plurality of power consuming devices can comprise one or more devices that report energy consumption inferred from an activity of the device that is proportional to energy consumption. At least one device can be associated directly with an account maintained by the accounting system. The plurality of power consuming devices can include one or more devices that communicate a predetermined energy consumption signal responsive to a standard product or service produced with the device.

An embodiment of the present invention can provide a system for delivering renewable energy from points of production to one or more points of use connected to an electrical power grid, comprising: (a) Means for encapsulating the renewable energy attributes of the points of production into standard RECs; (b) Means for tracking the standard RECs in an auditable accounting system; (c) Means for accumulation and transfer of the standard RECs, or fractions thereof, to points of use of electricity associated with users of the system; and (d) Means for matching transferred standard RECs to energy use at the points of use.

The present invention has been described in connection with various example embodiments. It will be understood that the above description is merely illustrative of the applications of the principles of the present invention, the scope of which is to be determined by the claims viewed in light of the specification. Other variants and modifications of the invention will be apparent to those of skill in the art.

What is claimed is:

1. An auditable, internet-based software system for facilitating widespread use of renewable energy, comprising:
(a) one or more data processing systems, configured to process and record data, and to communicate with users;
(b) an accounting subsystem implemented in software on one or more of the processing systems, configured to maintain balances of renewable energy credit accounts corresponding to a plurality of users;
(c) a credit adjustment subsystem implemented in software on one or more of the processing systems, configured to accept indications from a user corresponding to increases or decreases in a user's renewable energy credit account balance, and to communicate the increase or decrease with the accounting subsystem; and
(d) a credit matching subsystem implemented in software on one or more of the processing systems, configured to match actual electricity usage with a user's account and communicate with the accounting subsystem an adjustment to the user's account balance responsive to the matched usage.

2. A system as in claim 1, wherein the accounting subsystem is configured to accept only renewable energy credits certified by an operator of the system.

3. A system as in claim 1, wherein the accounting subsystem is configured to accept renewable energy credits from one or more validated sources other than the operator of the system.

4. A system as in claim 1, wherein the unit of renewable energy credit in the accounting subsystem represents between 0.01 to 1000 watt hours of energy.

5. A system as in claim 1, wherein the accounting subsystem is configured to accept external renewable energy credits corresponding to actual production of energy, and to translate such external credits to internal credits, wherein the internal credits comprise secure accounting tokens and are not used to track compliance with renewable energy credit legal requirements.

6. A method of obtaining renewable energy credits from a renewable energy generation system, comprising:
(a) determining an amount of time during which the renewable energy is to be obtained;
(b) determining a first renewable energy generation system from which the renewable energy credits are to be obtained;
(c) determining a percentage of the output of the first renewable energy generation system which is to be obtained; and
(d) establishing a payment relationship between the obtainer and the first renewable energy generation system corresponding to the determined percentage and transferring the corresponding renewable energy credits to the obtainer.

7. A method as in claim 6, wherein the payment relationship provides financing for the installation of the first renewable energy generation system.

8. A method as in claim 6, wherein the determined percentage is less than 1%.

9. A method as in claim 6, wherein the renewable energy generation system is a sanctioned system, and the renewable energy credits correspond directly to renewable energy produced by the first renewable energy generation system.

10. A method as in claim 6, wherein the renewable energy credits correspond to renewable energy produced by a second renewable energy generation system, distinct from the first renewable energy generation system, and equivalent to the determined percentage of the output of the first renewable energy generation system.

11. A system as in claim 1, wherein the accounting system in configured to increase the balance in a user's account responsive to renewable energy credits obtained by the user according to the method of claim 6.

12. A system as in claim 1, wherein the credit adjustment subsystem is configured to provide a competitive activity to a user, and to communicate to the accounting subsystem an adjustment in the user's account responsive to the user's participation in the competitive activity.

13. A system as in claim 1, wherein the credit adjustment subsystem is configured to accommodate transfers between accounts of users.

14. A system as in claim 1, wherein the credit adjustment subsystem is configured to communicate balance adjustments responsive web portals, power consumption meters, power production meters, power consuming devices, power producing devices, and mobile device apps.

15. A system as in claim 1, wherein the credit matching subsystem is configured to accept signals indicative of power consumption from power meters, web-connected appliances, web-connected power production devices, web-connected power consuming devices, or a combination thereof.

16. A system as in claim 1, wherein the credit matching subsystem is configured to accept signals indicative of power consumption from a meter connected with an electrical power grid and associated with a user.

17. A system as in claim 1, wherein the accounting subsystem is configured to aggregate renewable energy credits deducted from the accounts of a plurality of users and to retire standard RECs corresponding to the aggregated amount.

18. A system for managing consumption of renewable energy, comprising:
(a) a plurality of power consuming devices, each configured to communicate signals representative of power consumption to a computer network;
(b) a communications system configured to accept power consumption signals from the devices and communicate with an accounting system; and
(c) an accounting system implemented in software on one or more data processing systems, configured to maintain accounts for each of one or more users, where each account balance is adjusted responsive to power consumption of power consuming devices associated with the same user as the account.

19. A system as in claim 18, wherein the plurality of power consuming devices comprise one or more devices that report energy consumption inferred from an activity of the device that is proportional to energy consumption.

20. A system as in claim 18, wherein at least one device is associated directly with an account maintained by the accounting system.

21. A system as in claim 19, wherein the plurality of power consuming devices include one or more devices that communicate a predetermined energy consumption signal responsive to a standard product or service produced with the device.

22. A system as in claim 1, further comprising a communication subsystem configured to communicate information concerning a user's account to one or more distinct processing systems.

23. A system as in claim 22, wherein the one or more distinct processing systems comprise one or more of: software operating on a personal computer, a web app accessible from a web-enabled device, software implementing a social media website, software implementing a personal website.

24. A system as in claim 22, wherein the communication subsystem is further configured to communicate information concerning combinations of user accounts to one or more distinct processing systems.

25. A system for delivering renewable energy from points of production to one or more points of use connected to an electrical power grid, comprising:
(a) means for encapsulating the renewable energy attributes of the points of production into standard RECs;
(b) means for tracking the standard RECs in an auditable accounting system;
(c) means for accumulation and transfer of the standard RECs, or fractions thereof, to points of use of electricity associated with users of the system; and
(d) means for matching transferred standard RECs to energy use at the points of use.
